(19) United States
(12) Patent Application Publication
(10) Pub. No.: US 2010/0100664 A1
(43) Pub. Date: Apr. 22, 2010

(54) STORAGE SYSTEM

(75) Inventor: Norio Shimozono, Machida (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/332,758

(22) Filed: Dec. 11, 2008

(30) Foreign Application Priority Data
Oct. 21, 2008 (JP) 2008-270510

(51) Int. Cl. G06F 12/08; G06F 12/02; G06F 11/20

(52) U.S. Cl. 711/103; 711/118; 714/6; 711/E12.008; 711/E12.019; 711/E12.017; 714/E11.071

(57) ABSTRACT

Increase in read-access response time is avoided in a RAID storage system loaded with SSD. A process or is configured such that the processor sets SSD to a write-enable state, and sets different SSD, from which the same data can be acquired, to a write-disable state; allows predetermined data in CM to be written into the SSD in the write-enable state; receives a read request of data from a host computer; acquires object data of the read request from the different SSD in the case that a storage location of the data is the SSD being set to the write-enable state and transmits the acquired data to the host computer.

### CROSS REFERENCES TO RELATED APPLICATIONS

This application relates to and claims priority from Japanese Patent Application No. 2008-270510, filed on Oct. 21, 2008, the entire disclosure of which is incorporated herein by reference.

### BACKGROUND OF THE INVENTION

1. Field of the Invention

The present invention relates to a storage system having a plurality of solid state disks (SSD), which writes write object data (write data) into a cache memory, and then writes the data into a solid state disk.

2. Description of the Related Art

A storage system having a plurality of HDD (hard disk drives) has been known as a storage system for storing various data.

In such a storage system, as a technique for improving performance of data access and improving reliability of data storage, a technique is known, in which RAID (Redundant Arrays of Inexpensive Disks) is formed, and write data are temporarily stored in a cache memory, and then the data are copied to HDD (refer to Japanese Patent No. 3,264,465).

Moreover, a storage system is known, in which data are stored into a NAND flash memory that allows random access thereto at high speed compared with HDD (refer to U.S. Pat. No. 7,039,788).

### SUMMARY OF THE INVENTION

In the storage system having HDD as described in Japanese Patent No. 3,264,465, the followings are considered to achieve further speeding up of data access. That is, a processor, a cache memory, or HDD, each having relatively high performance, is loaded. Alternatively, the number of loaded processors, cache memories or HDD is increased. The processor or cache memory can be improved in performance by miniaturization of a semiconductor. However, HDD is hard to be improved in performance compared with the processor or cache memory because it has an internal, mechanical seek mechanism. Therefore, increase in number of loaded HDD is now inevitably required for the speeding up. However, the number of loaded HDD is increased, leading to a problem of increase in cost of a system.

Thus, as an idea, SSD including a NAND flash memory is loaded in place of HDD in a storage system. The NAND flash memory is a medium that cannot be overwritten unlike HDD. Therefore, in a storage system loaded with SSD, processing (reclamation processing) needs to be performed as described in U.S. Pat. No. 7,039,788, in which data are stored in a recordable manner into a flash memory of the SSD, and when volume of write data increases to a certain volume, latest data are copied into a new block of the flash memory, and after data are copied from a block, the data in the block are erased.

Therefore, when SSD storing read data is subjected to reclamation processing, a problem of reduction in access performance of the SSD is considered to occur. Specifically, in the case of cache miss, much time is required for read from SSD being subjected to reclamation processing, leading to increase in read-access response time.

Thus, an object of the invention is to provide a technique for avoiding increase in read-access response time in the storage system having SSD.

To achieve the object, a storage system according to a viewpoint of the invention having a cache memory and a plurality of solid state disks, which writes write object data into the cache memory, and then writes the data into a predetermined solid state disk; wherein the plurality of solid state disks include one or more solid state disk for storing data, and one or more, different solid state disk from which the same data as data stored in the solid state disk can be acquired; and the storage system has a setting unit that sets the one or more solid state disk to a write-enable state in which write of predetermined data written in the cache memory is enabled, and sets the one or more, different solid state disk, from which the same data as data stored in the one or more solid state disk can be acquired, to a write-disable state in which data write is disabled; a write control unit that allows predetermined data in the cache memory to be written into the solid state disk being set to the write-enable state; a receive unit that receives a read request of data stored in the solid state disk from an external device; an acquisition unit that acquires object data of the read request from the one or more, different solid state disk, from which the same data as data stored in the one or more solid state disk can be acquired, in the case that a storage location of the object data of the read request is the one or more solid state disk being set to the write-enable state; and a transmit unit that transmits the acquired data to the external device.

### BRIEF DESCRIPTION OF THE DRAWINGS

FIG. 1 shows a schematic configuration of a computer system according to an embodiment of the invention, and an outline of data transfer for a RAID-10 RAID group in the computer system;

FIG. 2 shows a hardware block diagram of a storage system according to an embodiment of the invention;

FIG. 3 shows a functional block diagram of processing for a RAID-10 RAID group in the storage system according to an embodiment of the invention;

FIG. 4 shows a diagram showing an LU configuration information table according to an embodiment of the invention;

FIG. 5 shows a diagram showing a logical volume configuration information table according to an embodiment of the invention;

FIG. 6 shows a diagram showing RAID group configuration information according to an embodiment of the invention;

FIG. 7 shows a diagram showing cache control information according to an embodiment of the invention;

FIG. 8 shows a diagram showing mapping between a cache directory table and a slot control block according to an embodiment of the invention;

FIG. 9 shows a diagram showing mapping between a clean queue and slot control blocks according to an embodiment of the invention;

FIG. 10 shows a diagram showing SSD access mode information according to an embodiment of the invention;

FIG. 11 shows a state transition diagram of a cache slot for data cache in a RAID-10 RAID group according to an embodiment of the invention;

FIG. 12 shows a flowchart of stage processing for a RAID-10 RAID group according to an embodiment of the invention;

FIG. 13 shows a flowchart of destage processing for a RAID-10 RAID group according to an embodiment of the invention;

FIG. 14 shows a flowchart of SSD mode changing processing for a RAID-10 RAID group according to an embodiment of the invention;

FIG. 15 shows a schematic configuration of another computer system according to an embodiment of the invention, and an outline of data transfer for a RAID-5 RAID group in the computer system;

FIG. 16 shows a functional block diagram of processing for a RAID-5 RAID group in a storage system according to an embodiment of the invention;

FIG. 17 shows a state transition diagram of a cache slot for data cache in a RAID-5 RAID group according to an embodiment of the invention;

FIG. 18 shows a flowchart of stage processing for a RAID-5 RAID group according to an embodiment of the invention;

FIG. 19 shows a flowchart of parity generate processing according to an embodiment of the invention;

FIG. 20 shows a flowchart of destage processing for a RAID-5 RAID group according to an embodiment of the invention;

FIG. 21 shows a flowchart of SSD mode changing processing for a RAID-5 RAID group according to an embodiment of the invention; and

FIG. 22 shows a block diagram of RAID group configuration information according to a modification of the invention.

### DESCRIPTION OF THE PREFERRED EMBODIMENT

A preferred embodiment of the invention will be described with reference to drawings. The following embodiment is not intended to limit the invention, and any of elements and combinations thereof described in the embodiment are not essentially needed for a solution according to the invention.

Hereinafter, a storage system according to an embodiment of the invention is described.

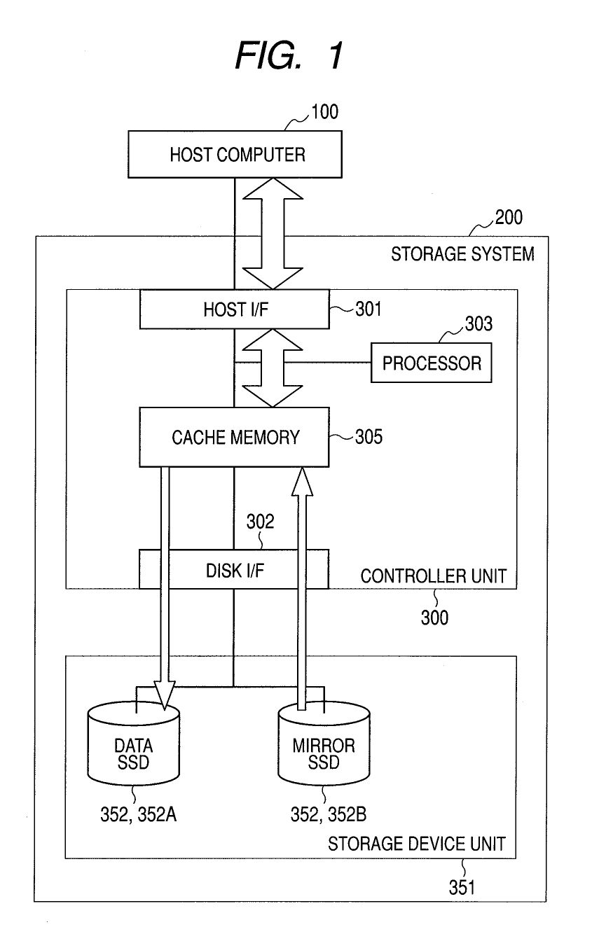

FIG. 1 shows a schematic configuration of a computer system according to an embodiment of the invention, and an outline of data transfer for a RAID-10 RAID group in the computer system.

The computer system has a host computer 100 as an example of an external device, and a storage system 200. A plurality of host computers 100 may be provided. The storage system 200 has a controller unit 300, and a storage device unit 351. The storage device unit 351 includes a plurality of SSD (Solid State Disk) 352. The SSD 352 is loaded with a NAND flash memory and a cache memory, and subjected to processing (reclamation processing), in which data are stored in a recordable manner into a block of the NAND flash memory, and at a predetermined time point, for example, at a time point when volume of data written into a block reaches a certain volume, latest data are copied into a new block of the flash memory, and after data in a block are copied, the data are erased so that the block is reclaimed into a storable block. The storage device unit 351 may include not only the SSD 352, but also a different type of storage device such as HDD.

The storage system 200 of the embodiment may include a plurality of RAID groups configured by at least two SSD 352 among the plurality of SSD 352. For example, SSD 352A and SSD 352B configure a RAID-10 RAID group (that is, a configuration where mirroring and striping are performed).

In the storage system 200, a storage space of one RAID group can be provided as one or several logical volume (LVOL). Each logical volume is mapped with a volume identifier, for example, LUN (Logical Unit Number).

The controller unit 300 includes a host I/F 301, a disk I/F 302, a cache memory (CM) 305, and a processor (MP) 303.

The host I/F 301 is an interface via which the storage system 200 communicates to the host computer (host) 100, and for example, includes a fiber channel port. The disk I/F 302 is an interface via which the controller unit 300 communicates to the SSD 352, and for example, includes a fiber channel port, or SAS (Serial Attached SCSI) port. The CM 305 temporarily stores data received from the host 100, data read from the SSD 352 and the like.

The MP 303 performs processing based on a SCSI command transmitted from the host 100, and controls data transfer to/from the host 100. Moreover, when the MP 303 receives a read command (read request) from the host 100, the MP 303 determines whether object data (read data) of the read command are stored in the CM 305, and when the data are not stored (that is, in the case of cache miss), the MP 303 stages (reads) the read data from the SSD 352 into the CM 305, and then transfers the read data into the host 100.

When the MP 303 receives a write command (write request) from the host 100, the MP 303 stores write object data (write data) into the CM 305, and asynchronously destages (writes) the write data from the CM 305 to the SSD 352.

Moreover, while the MP 303 sets SSD 352 at one side of a RAID-10 RAID group (for example, data SSD: data SSD 352A) to a destage mode (destage-enable state: write-access-enable), the MP 303 sets SSD 352 at the other side of the RAID group, from which the same data can be read, (for example, mirror SSD: mirror SSD 352B) to a stage mode (destage-disable state: write-access-disable). In the case of such setting, when read access is performed to the SSD 352 in the destage mode, the MP 303 stages the same data as data of a read access object from the SSD 352 in the stage mode. According to this, the MP 303 can stage desired data from the SSD 352 in the stage mode, which is secured to be not subjected to the reclamation processing. Therefore, increase in read-access response time can be avoided.

Moreover, when a predetermined condition is satisfied (for example, a certain volume of dirty data are destaged), the MP 303 interchanges respective modes of the SSD 352 in the stage mode and the SSD 352 in the destage mode. For example, the MP 303 sets the data SSD 352A to the stage mode, and sets the mirror SSD 352B to the destage mode. Thus, write data stored in the CM 305 can be destaged to the mirror SSD 352B.

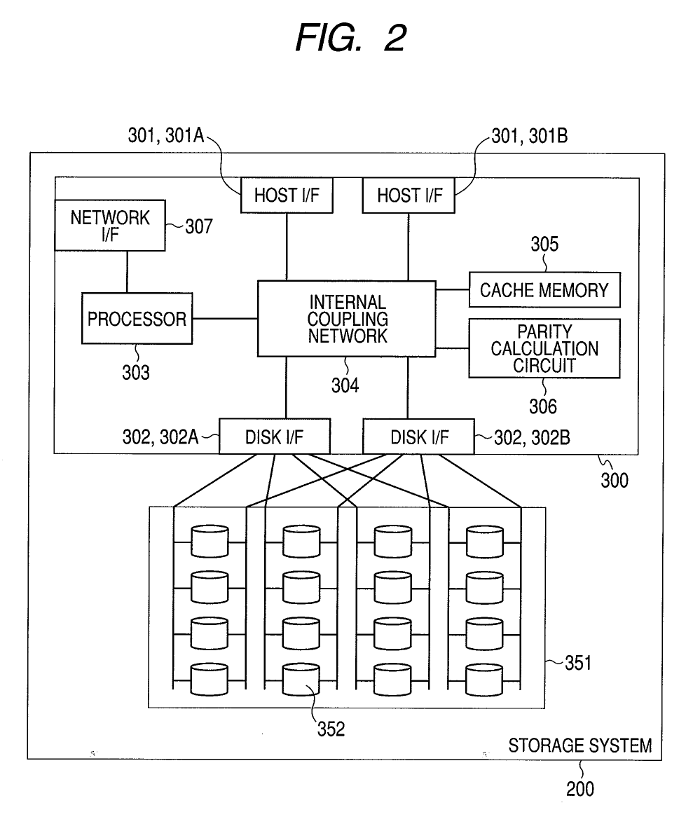

FIG. 2 shows a hardware block diagram of a storage system according to an embodiment of the invention.

The controller unit 300 of the storage system 200 has at least one host I/F 301, at least one disk I/F 302, the MP 303, an internal coupling network 304, the CM 305, a parity calculation circuit 306, and a network I/F 307.

The internal coupling network 304 couples the host I/F 301, disk I/F 302, MP 303, CM 305, and parity calculation circuit 306 to one another. The internal coupling network 304 includes, for example, a crossbar switch or a bus. The parity calculation circuit 306 performs calculation of parity in RAID-5 and RAID-6.

The network I/F 307 is an interface via which an external computer is connected, and for example, includes an Ethernet (registered trademark) port. Various setting of the storage system 200 can be made by the external computer through the network I/F 307.

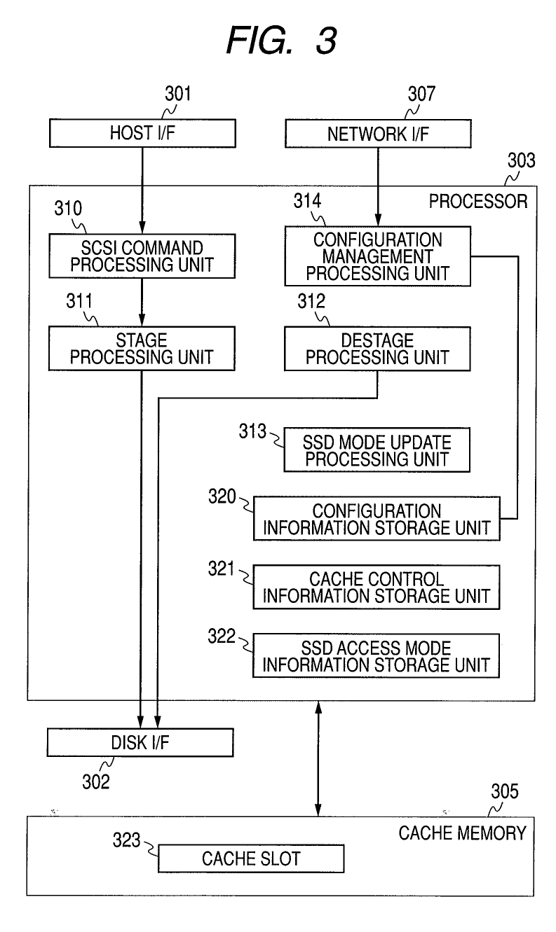

FIG. 3 shows a functional block diagram of processing for a RAID-10 RAID group in the storage system according to an embodiment of the invention.

The processor 303 includes a SCSI command processing unit 310 as an example of a receive or transmit unit, a stage processing unit 311 as an example of an acquisition unit, a destage processing unit 312 as an example of a write control unit, an SSD mode update processing unit 313 as an example of a setting unit, a first ratio determination unit, or a second ratio determination unit, a configuration management processing unit 314, a configuration information storage unit 320, a cache control information storage unit 321, and an SSD access mode information storage unit 322.

The cache memory 305 stores a plurality of cache slots 323. Each of the cache slots 323 temporarily stores a certain unit of logical volume data.

The SCSI command processing unit 310 processes a SCSI command received from the host 100 through the host I/F 301. Moreover, the unit 310 transmits a SCSI command or the like to the host 100 through the host I/F 301. The SCSI command processing unit 310 receives write data from the host 100. Moreover, the SCSI command processing unit 310 transmits read data from the cache memory 305 to the host 100. The stage processing unit 311 reads (stages) read data from the SSD 352 into the CM 305. The stage processing unit 311 is called by the SCSI command processing unit 310 when cache miss occurs during read command processing.

The destage processing unit 312 writes (destages) write data into the SSD 352, the write data being written from the host 100 into CM 305.

The SSD mode update processing unit 313 performs switching processing of SSD 352 into a destage mode. More specifically, the SSD mode update processing unit 313 performs update processing of access mode information in the SSD access mode information storage unit 322. The configuration management processing unit 314 receives a request from the external computer through the network I/F 307, and performs setting processing of configuration information of the storage system 200 in the configuration information storage unit 320.

The configuration information storage unit 320 stores the configuration information of the storage system 200. For example, the configuration information storage unit 320 stores an LU configuration information table 3205 indicating mapping between a set of the host I/F 301 and LUN and a logical volume, a logical volume configuration information table 3206 indicating mapping between a logical volume and a RAID group, and RAID group configuration information 3201 indicating mapping between a RAID group and SSD 352.

The cache control information storage unit 321 stores cache control information for controlling logical volume data to be stored into the CM 305 for each cache slot 323.

The SSD access mode information storage unit 322 stores information showing whether read/write access can be performed to the SSD 352. The information is updated by the SSD mode update processing unit 313.

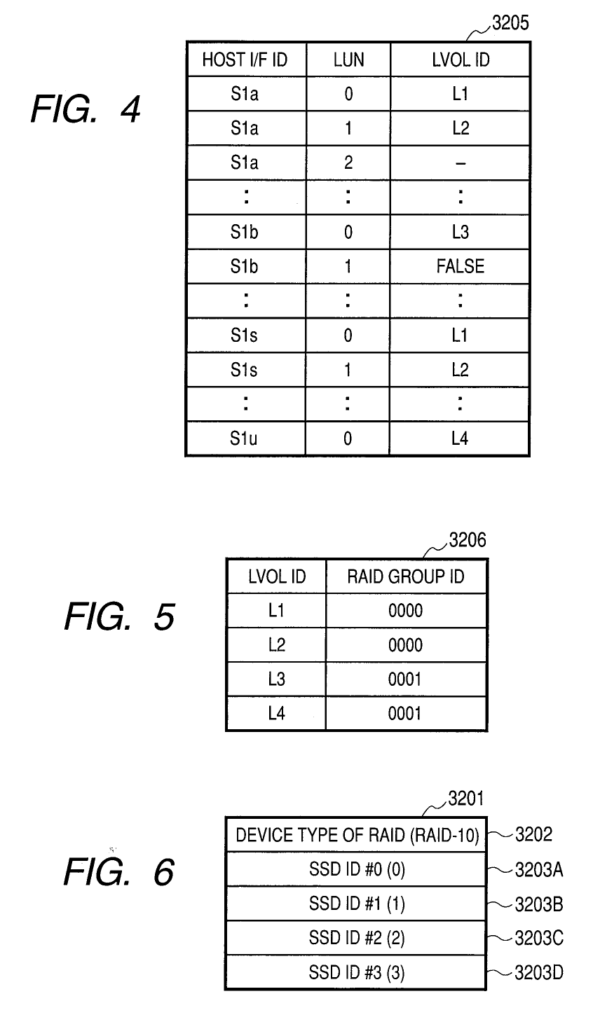

FIG. 4 shows a diagram showing an LU configuration information table according to an embodiment of the invention.

The LU configuration information table 3205 maps each set of host I/F 301 and LUN to a logical volume. Specifically, the LU configuration information table 3205 stores a host I/F identifier (host I/F ID), LUN (logical unit number), and a logical volume identifier (LVOL ID) being mapped to one another. For example, it is known that a logical volume mapped to LUN “0” has ID “L1” for host I/F 301 having host I/F ID of “S1a”.

FIG. 5 shows a diagram showing a logical volume configuration information table according to an embodiment of the invention.

The logical volume configuration information table 3206 maps a logical volume to a RAID group. Specifically, the logical volume configuration information table 3206 stores LVOL ID and RAID group ID being mapped to each other. In the figure, the logical volume is mapped to the RAID group one-on-one. However, this is not limitative, and the logical volume and the RAID group may be divided into smaller storage area respectively so as to be mapped to each other N-on-M (N and M are an optional integer respectively).

FIG. 6 shows a diagram showing RAID group configuration information according to an embodiment of the invention.

The RAID group configuration information 3201 is provided being mapped to each RAID group, showing mapping between each RAID group and SSD 352. The RAID group configuration information 3201 includes RAID information 3202 and a plurality of SSD-ID 3203. The RAID information 3202 shows a device type (RAID level) of a corresponding RAID group. The SSD-ID 3203 shows ID of SSD 352 configuring a RAID group. FIG. 6 shows that a corresponding RAID group is RAID-10, and SSD-ID includes four SSD-ID of ID0 to ID3. For example, a data SSD configuration (data SSD) includes two SSD 352 having ID of “0” and “1”, and a mirror SSD configuration (mirror SSD) includes two SSD 352 having ID of “2” and “3”.

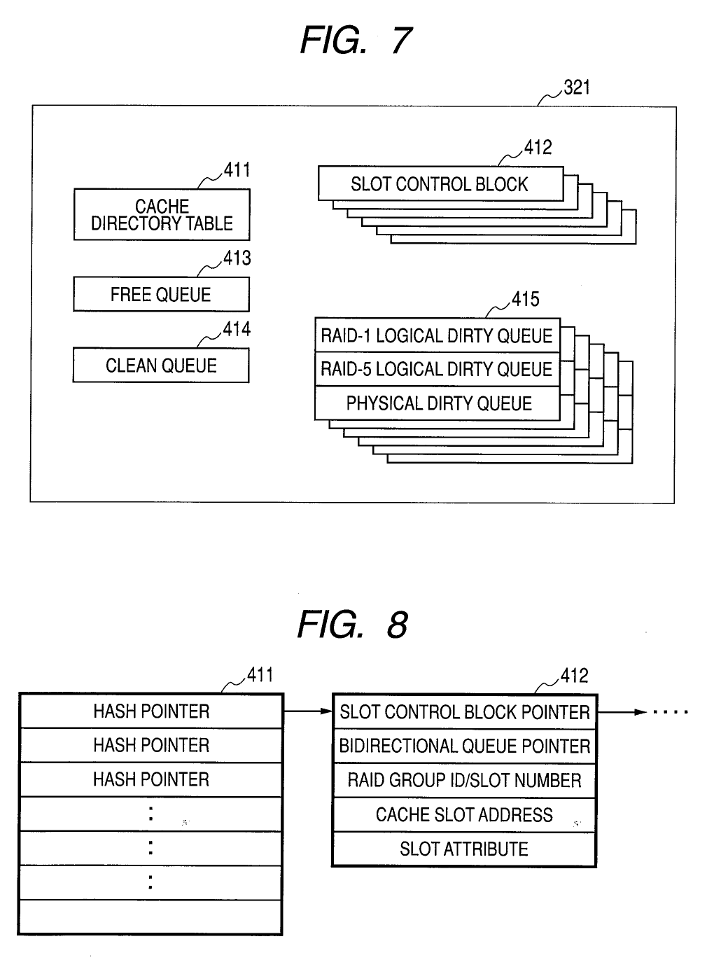

FIG. 7 shows a diagram showing cache control information according to an embodiment of the invention.

The cache control information storage unit 321 includes a cache directory table 411 for searching the cache slot 323 from a logical block address (LBA) of a logical volume, slot control blocks 412 showing a state of each cache slot 323, and queue pointers 413, 414 and 415 for connecting between slot control blocks 412 having the same slot state so that search can be performed at high speed as the cache control information. Dirty queues 415 are provided as many as the SSD 352, and include three types of queues: a RAID-1 logical dirty queue, a RAID-5 logical dirty queue and a physical dirty queue.

FIG. 8 shows a diagram showing mapping between a cache directory table and a slot control block according to an embodiment of the invention.

The cache directory table 411 is a table for searching a slot control block 412 from a RAID group and a slot number, and includes a plurality of hash pointers. The slot number is an address number when a RAID group is divided by a cache slot size (for example, 4 kB). Therefore, a hash pointer is connected with a plurality of slot control blocks 412 through a slot control block pointer.

Hash calculation is performed using a RAID group and a slot number to calculate a hash pointer from which search is started, and each slot control block 412 can be searched by tracing the slot control blocks 412 from the hash pointer.

In the embodiment, the MP 303 uses address information (for example, a combination of LUN and LBA) specified by a SCSI command from the host 100 to refer configuration information in the configuration information storage unit 320, and thus specifies LVOL ID. The MP 303 can specify a RAID group and a slot number from the specified LVOL ID and LBA. In addition, the MP 303 makes the RAID group ID and the slot number into hash, and thus obtains a directory entry point, and can specify a slot control block 412 from a corresponding hash pointer.

The slot control block 412 includes information corresponding to each cache slot 323. Several kinds of information elements are described in the slot control block 412. The slot control block 412 may include, for example, a slot control block pointer, a bidirectional queue pointer, RAID group ID/slot number, a cache slot address, and a slot attribute. The bidirectional queue pointer connects the slot control blocks 412 in the same slot state to each other, and has two pointers to meet two-way communication.

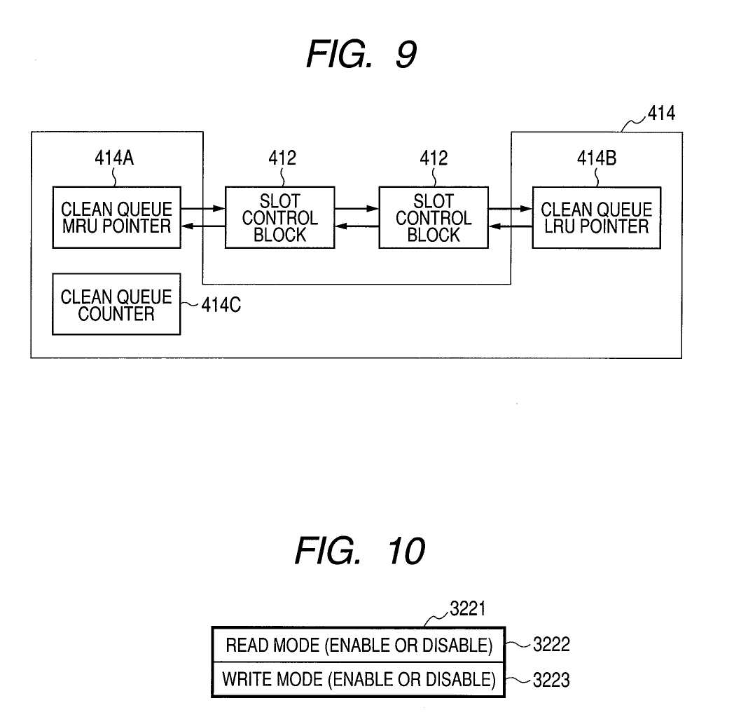

FIG. 9 shows a diagram showing mapping between a clean queue and slot control blocks according to an embodiment of the invention. While the figure shows a clean queue as an example, a free queue or dirty queue has the same structure.

The clean queue 414 includes three kinds of information of a clean queue MRU (Most Recently Used) pointer 414A, a clean queue LRU (Least Recently Used) pointer 414B, and a clean queue counter 414C.

The clean queue MRU pointer 414A shows a slot control block 412 corresponding to a slot being most recently used. The clean queue LRU pointer 414B shows a slot control block 412 corresponding to a slot being least recently used. In the embodiment, since the clean queue MRU pointer 414A is connected to the clean queue LRU pointer 414B through the bidirectional queue pointer of the slot control block 412, a slot control block 412 having a particular slot attribute can by promptly searched. The clean queue counter 414C stores total number of clean slot control blocks 412. The total number in the clean queue counter 414C is copied when the number of the clean slot control blocks 412 increases or decreases. Thus, the total number of the clean slot control blocks 412 can be promptly grasped.

FIG. 10 shows a diagram showing SSD access mode information according to an embodiment of the invention.

The SSD access mode information storage unit 322 includes SSD access mode entries 3221 having the same number as number of SSD 352. Each SSD access mode entry 3221 includes read mode setting 3222 and write mode setting 3223, and takes a state of either “enable” or “disable”. In the case that the read mode setting 3222 is disable, and the write mode setting 3223 is enable, the case shows that a state of corresponding SSD 352 is a destage-enable state (write enable state). In the case that the read mode setting 3222 is enable, and the write mode setting 3223 is disable, the case shows that a state of corresponding SSD 352 is a destage-disable state (write disable state).

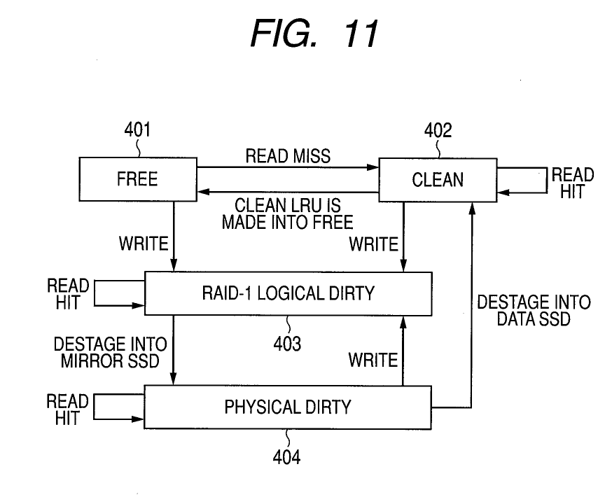

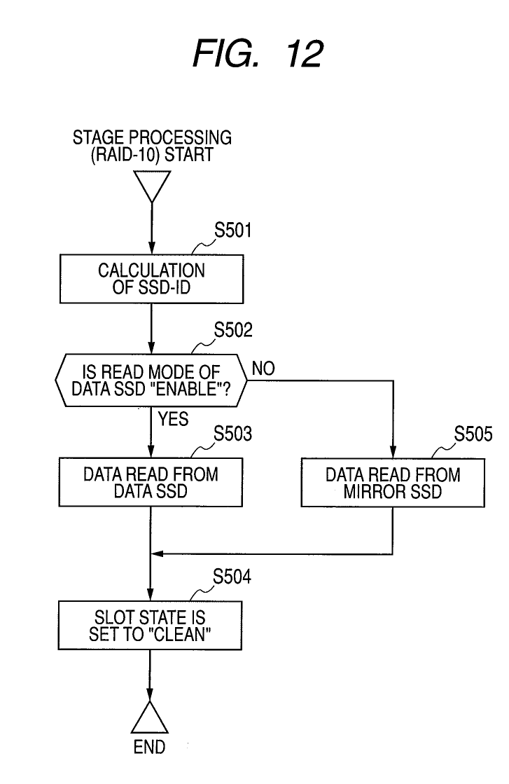

FIG. 11 shows a state transition diagram of a cache slot for data cache in a RAID-10 RAID group according to an embodiment of the invention.

A slot state of the cache slot 323 is one of free 401, clean 402, RAID-1 logical dirty 403, and physical dirty 404. The free 401 shows that a state of the cache slot 323 is an unused slot state. The clean 402 shows a slot state that the cache slot 323 includes logical volume data, and the data have been destaged to data SSD 352 and mirror SSD 352. The RAID-1 logical dirty 403 shows a slot state that the cache slot 323 includes logical volume data, and the data need to be destaged to both of the data SSD 352 and the mirror SSD 352. The physical dirty 404 shows a slot state that the cache slot 323 includes logical volume data, and while the data have been destaged to the mirror SSD 352, the data need to be destaged to the data SSD 352.

When cache miss occurs in the SCSI command processing unit 310, the MP 303 allocates a cache slot 323 from cache slots 323 of free 401 for caching corresponding data. When no cache slot 323 of free 401 exists, the MP 303 makes a slot state of an LRU cache slot 323 in cache slots 323 of clean 402 into free 401, thereby the MP 303 secures a cache slot 323 of free 401.

Moreover, the MP 303 stores write data from the host 100 into the allocated cache slot 323 of free 401, so that it sets a slot state of the cache slot 323 to RAID-1 logical dirty 403. Moreover, when the MP 303 completes destage of the data in the cache slot 323 of RAID-1 logical dirty 403 into mirror SSD 352, the MP 303 sets the cache slot 323 to physical dirty 404. Moreover, when the MP 303 completes destage of the data in the cache slot 323 of physical dirty 404 to the data SSD 352, it sets the cache slot to clean 402.

When the MP 303 performs each state transition of a cache slot 323, the MP 303 increases or decreases a state counter (for example, clean queue counter 414C), which stores number of cache slots 323 in each state, depending on a transited state, so that the MP 303 manages the number of cache slots in each state.

Next, processing of the storage system according to an embodiment of the invention is described.

FIG. 12 shows a flowchart of stage processing for a RAID-10 RAID group according to an embodiment of the invention.

The stage processing is called and carried out when cache read miss occurs in the SCSI command processing unit 310.

First, the MP 303 refers RAID group configuration information 3201 to acquire SSD-ID of data SSD 352 storing read data, and SSD-ID of mirror SSD 352 (step S501). Next, the MP 303 refers an SSD access mode entry 3221 of the SSD access mode information storage unit 322 corresponding to the data SSD 352 to determine whether a read mode of the SSD 352 is “enable” (step S502).

As a result of determination, when the read mode is “enable” (step S502: Yes), since a state of the data SSD 352 is not the destage-enable state, the MP 303 reads object data from the data SSD 352, then stores the data into a cache slot 323 of the CM 305, and then transmits the data to the host 100 as a request source (step S503). Next, the MP 303 sets a slot state of the cache slot 323 to “clean”, and finishes the stage processing (step S504).

On the other hand, as a result of determination of the step S502, when the read mode is not “enable” (step S502: No), since a state of the data SSD 352 may be the destage-enable state, the MP 303 reads data from the mirror SSD 352, then stores the data into a cache slot 323, and then transmits the data to the host 100 as a request source (step S505). Next, the MP 303 sets a slot state of the cache slot 323 to “clean”, and finishes the stage processing (step S504).

According to such processing, the MP 303 is prevented from reading data from SSD 352 that may be in the destage-enable state. Therefore, data read can be avoided from SSD 352 in the destage-enable state, which may be subjected to reclamation processing. Thus, data can be read from SSD 352 that may not be subjected to reclamation processing, consequently increase in access time due to reclamation processing can be avoided.

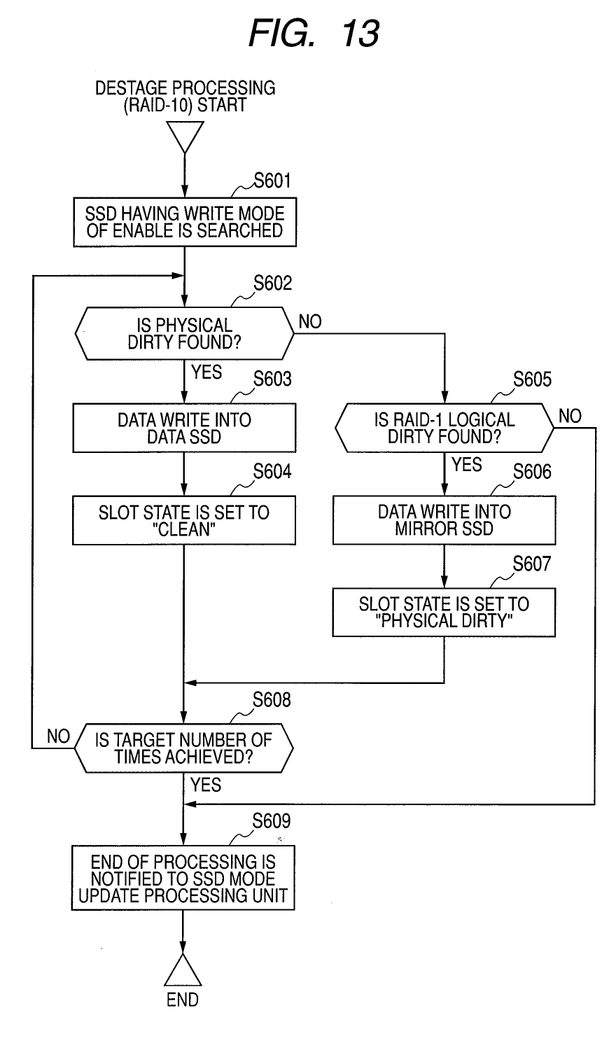

FIG. 13 shows a flowchart of destage processing for a RAID-1 RAID group according to an embodiment of the invention.

The destage processing is, for example, periodically called by the MP 303, and carried out for each RAID-10 RAID group as an object. First, the MP 303 refers RAID group configuration information 3201 and an SSD access mode entry 3221 to search SSD 352 having a write mode of “enable” from a RAID group (step S601).

The MP 303 searches a cache slot 323 having a slot state of “physical dirty” from cache slots 323 corresponding to the SSD 352 found in the step S601 (step S602).

As a result, when the MP 303 finds a cache slot 323 of physical dirty (step S602: Yes), the MP 303 writes data (dirty data) stored in the cache slot 323 into the relevant SSD 352 (in this case, data SSD 352) (step S603). Next, when the MP 303 finishes writing the dirty data into the data SSD 352, the MP 303 sets a slot state of the cache slot 323 to “clean” (step S604), and advances the processing to step S608. Thus, a cache slot 323 of physical dirty, which can be early transited into clean, can be preferentially processed to be into clean.

On the hand, when no cache slot 323 corresponding to the SSD 352 is found (step S602: No), the MP 303 searches a cache slot 323 having a slot state of “RAID-1 logical dirty” from cache slots 323 corresponding to the SSD 352 found in the step S601 (step S605).

As a result, when the MP 303 finds a cache slot 323 having a slot state of “RAID-1 logical dirty” (step S605: Yes), the MP 303 writes data stored in the cache slot 323 into the relevant SSD 352 (in this case, mirror SSD 352) (step S606). Next, when the MP 303 finishes writing the data into the mirror SSD 352, the MP 303 sets a slot state of the cache slot 323 to “physical dirty” (step S607), and advances the processing to the step S608.

When the MP 303 does not find a cache slot 323 having a slot state of “RAID-1 logical dirty” from the corresponding cache slots 323 (step S605: No), the MP 303 advances the processing to step S609.

In the step S608, the MP 303 determines whether the number of write times reaches the predetermined target number of times (for example, predetermined number of times: predetermined throughput) (step S608) When the number of times does not reach the target number of times (step S608: No), the MP 303 advances the processing to the step S602. On the other hand, when the number of times reaches the target number of times (step S608: Yes), the MP 303 advances the processing to step S609.

In the step S609, the MP 303 notifies end of the destage processing to the SSD mode update processing unit 313, and finishes the processing.

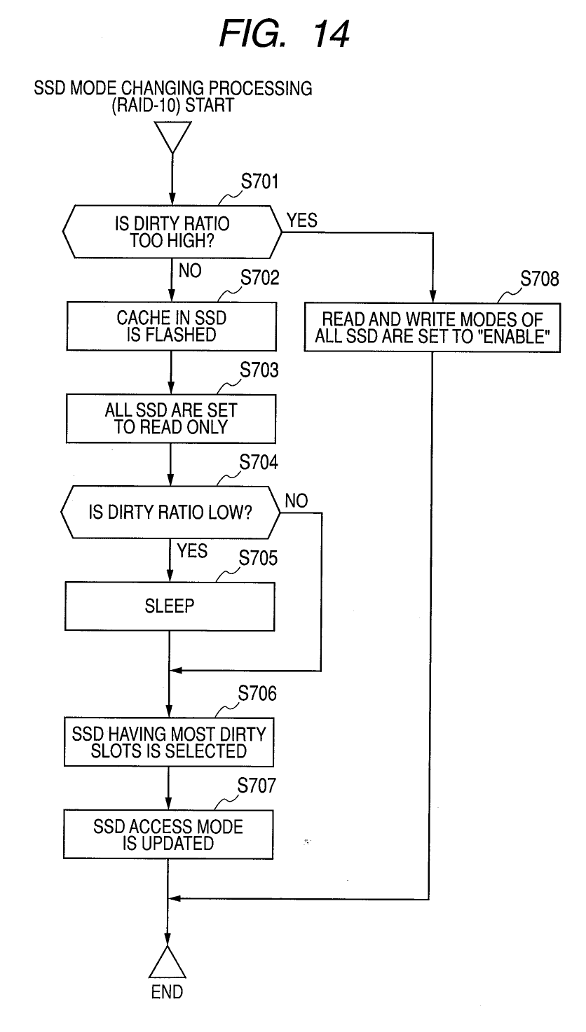

FIG. 14 shows a flowchart of SSD mode changing processing for a RAID-10 RAID group according to an embodiment of the invention. The SSD mode changing processing is performed by the SSD mode update processing unit 313 for each RAID group (RAID-10 RAID group).

First, the MP 303 determines whether a ratio of data volume of dirty data corresponding to the RAID group as a processing object to storage capacity of the CM 305 is too high (step S701). In the embodiment, when the ratio exceeds 70%, the MP 303 determines the ratio to be too high.

When the ratio of dirty data is not too high (step S701: No), the MP 303 issues a cache flash command to SSD 352 having a write mode of “enable” (step S702). The cache flash command includes a “FLUSH CACHE” command in the case of ATA, and includes a command defined as a “SYNCHRONIZE CACHE” command in the case of SCSI. Thus, in the SSD 352 issued with the command, data write is performed from a cache memory in the SSD 352 into a NAND flash memory, and reclamation processing is performed as needed.

When cache flash for the SSD 352 is completed, the MP 303 sets read modes of all SSD 352 configuring a RAID group as a processing object to “enable”, and sets write modes thereof to “disable” (step S703). Next, the MP 303 determines whether a ratio of dirty data corresponding to the RAID group as the processing object to the capacity of the CM 305 is extremely low (step S704). In the embodiment, when the ratio is not more than 5%, the MP 303 determines the ratio to be extremely low.

When the ratio of the dirty data to the capacity of the CM 305 is determined to be extremely low (step S704: Yes), the MP 303 sleeps the SSD mode update processing unit 313 for a while (step S705). For example, sleep time may be a fixed time (for example, 1 sec). Alternatively, it is acceptable that the MP 303 acquires an access load at the sleep time point, and time is variably determined depending on the access load. According to this, since destage is not performed to the SSD 352 during the sleep time, influence of delay on read access caused by destage processing can be appropriately prevented.

When the ratio of the dirty data to the capacity of the CM 305 is not determined to be extremely low (step S704: No), or sleep time has passed, the MP 303 selects SSD 352 having the most cache slots 323 in a dirty state (RAID-1 logical dirty and physical dirty) in the RAID group as a processing object (step S706). Next, the MP 303 sets the selected SSD 352 to a destage-enable state. More specifically, the MP 303 sets a read mode of an SSD access mode entry 3221 of the relevant SSD 352 to “disable”, and sets a write mode thereof to “enable” (step S707).

When the ratio of the dirty data is determined to be too high (step S701: Yes), the MP 303 sets all SSD 352 configuring a RAID group as a processing object to both of a stage-enable state and a destage-enable state. More specifically, the MP 303 sets a read mode and write modes of SSD access mode entries 3221 of all SSD 352 to “enable” (step S708). According to this, the MP 303 may improve throughput of destage, and the CM 305 can be prevented from being filled with dirty data.

Next, description is made on a configuration and processing in the case that a RAID-5 RAID group is configured in the computer system according to the embodiment.

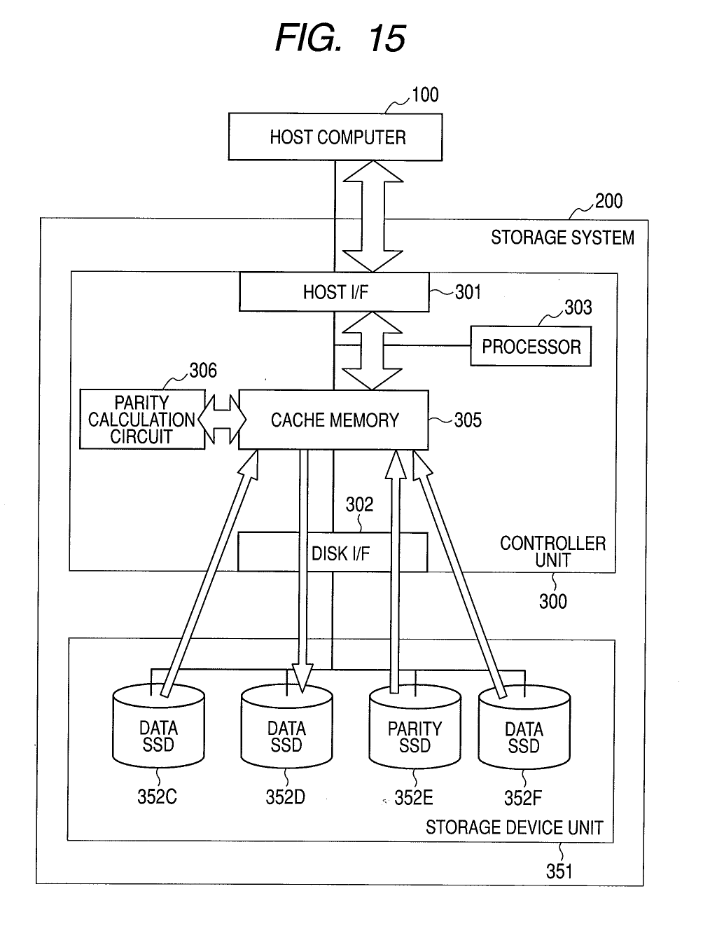

FIG. 15 shows a schematic configuration of another computer system according to an embodiment of the invention, and an outline of data transfer for a RAID-5 RAID group in the computer system. Differences from the configuration of the RAID-10 RAID group shown in FIG. 1 are mainly described.

In a storage device unit 351, a plurality of (in the figure, four) SSD 352 (SSD 352C to SSD 352F) configure a RAID-5 RAID group.

In a controller unit 300, a parity calculation circuit 306 is provided in addition to the configuration shown in FIG. 1, and used for processing. The parity calculation circuit 306 performs XOR arithmetic operation in RAID-5, or Galois field arithmetic operation in RAID-6. The parity calculation circuit 306 has a function of calculating new parity data based on new data as a write object, old data written in a write object area, and old parity data calculated using the old data, and a function of restoring remaining data from a plurality of data (in the case of a 3D+P configuration, two sets of data) and parity data.

When the MP 303 sets part of SSD 352 in a RAID group (in the case of RAID-5, one of SSD 352) to a destage-enable state, in the case that data need to be read from the SSD 352 in the destage-enable state, the MP 303 transfers data and parity data in remaining SSD 352 to the parity calculation circuit 306, and allows the parity calculation circuit 306 to restore the data into target data, and stores the restored data into CM 305. For example, in FIG. 15, when SSD 352D is in a destage-enable state, in the case that data stored in the SSD 352D need to be staged, the MP 303 acquires data and parity data from SSD 352C, SSD 352E and SSD 352F, and allows the parity calculation circuit 306 to restore the data, and stores the restored data into CM 305.

According to this, the MP 303 can generate and stage desired data using data and parity data in a plurality of SSD 352D (in the example, SSD 352C, SSD 352E and SSD 352F), which are secured to be not subjected to reclamation processing. Therefore, an increase in read access response time can be avoided.

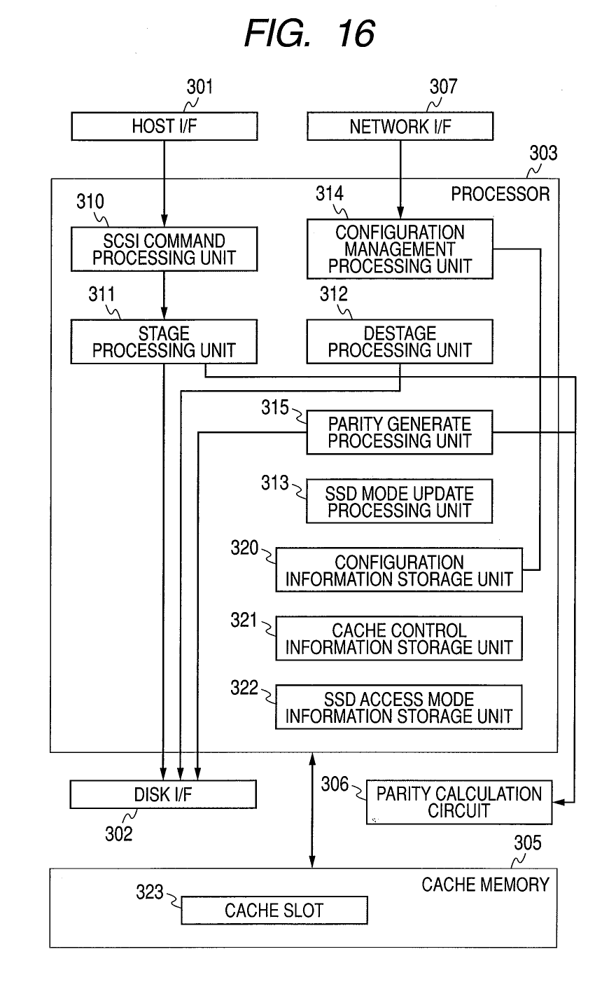

FIG. 16 shows a functional block diagram of processing for a RAID-5 RAID group in a storage system according to an embodiment of the invention. Differences from the configuration of the RAID-10 RAID group shown in FIG. 3 are mainly described.

In the MP 303, a parity generate processing unit 315 is further necessary in addition to the configuration shown in FIG. 3. The parity generate processing unit 315 performs processing of allowing the parity calculation circuit 306 to calculate new parity data based on new data as a write object (write data), old data written in a write object area, and old parity data calculated using the old data, and storing the parity data into the CM 305 as dirty data.

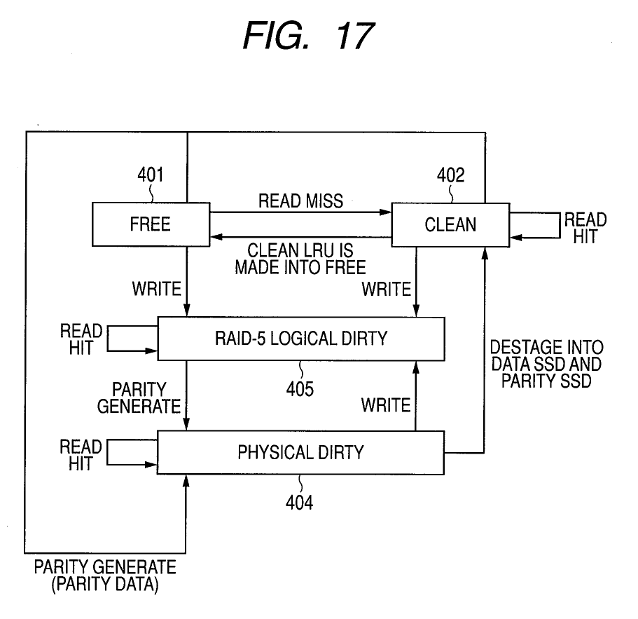

FIG. 17 shows a state transition diagram of a cache slot for data cache in a RAID-5 RAID group according to an embodiment of the invention. Differences from the state transition in the RAID-10 RAID group shown in FIG. 11 are mainly described.

First, a state of a cache slot 323 in the RAID-5 RAID group includes a RAID-5 logical dirty 405 in place of the RAID-1 logical dirty 403. The RAID-5 logical dirty 405 shows a slot state that a cache slot 323 includes logical volume data, and new parity data corresponding to the logical volume data need to be generated.

When the MP 303 stores write data from the host 100, the MP 303 sets a cache slot 323 storing the write data to the RAID-5 logical dirty 405. Moreover, when the MP 303 completes generating the parity data corresponding to the data stored in the cache slot 323 of the RAID-5 logical dirty 405, the MP 303 sets the relevant cache slot 323 and a cache slot 323 for storing corresponding parity data to physical dirty 404. Moreover, when the MP 303 finishes destaging data stored in the cache slot 323 of physical dirty 404 to corresponding data SSD 352, the MP 303 changes state of the corresponding cache slot 323 from physical dirty 404 to clean 402. Moreover, when the MP 303 finishes destaging parity data stored in the cache slot 323 of physical dirty 404 to corresponding SSD 352, the MP 303 sets a cache slot 323 corresponding to the parity data to clean 402.

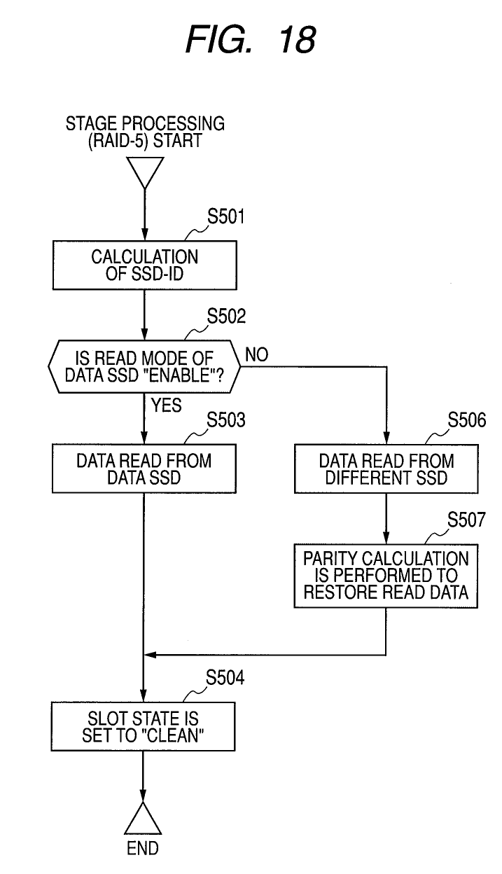

FIG. 18 shows a flowchart of stage processing for a RAID-5 RAID group according to an embodiment of the invention. The same step as in the stage processing for the RAID-10 RAID group shown in FIG. 12 is marked with the same number, and different points are mainly described.

In the stage processing for the RAID-5 RAID group, steps S506 and S507 are performed in place of the step S505 in FIG. 12.

That is, when the read mode is not “enable” (step S502: No), since SSD 352 storing the read data may be in a destage-enable state, the MP 303 reads data and parity data from a plurality of different SSD 352 that store data and parity data necessary for restoring the relevant data (step S506), then starts the parity calculation circuit 306 for restoring an object data, and then restores the object data from the read data and read parity data, and stores the restored data into a cache slot 323 of the CM 305, and transmits the relevant data to a request source (step S507).

According to such processing, the MP 303 restores request object data without reading data from SSD 352 that may be in the destage-enable state. Therefore, data read can be avoided from SSD 352 in the destage-enable state, which may be subjected to reclamation processing. Thus, the MP 303 can respond a request by restoring the request object data from data and parity data in different SSD 352 that may not be subjected to reclamation processing, consequently increase in access time due to reclamation processing can be avoided.

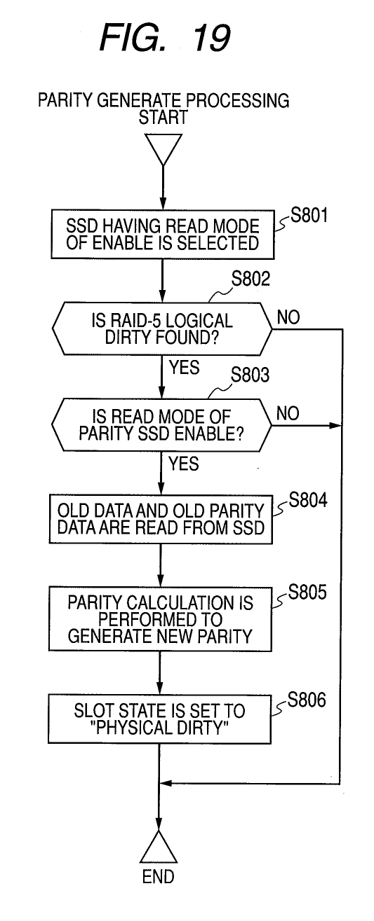

FIG. 19 shows a flowchart of parity generate processing according to an embodiment of the invention.

The parity generate processing is periodically called, and performed by the parity generate processing unit 315 for each RAID group (in the example, RAID-5 RAID group).

First, the MP 303 refers RAID group configuration information 3201 and an SSD access mode entry 3221 to search SSD 352 having a read mode of “enable” (step S801).

The MP 303 searches a cache slot 323 of “RAID-5 logical dirty” from cache slots 323 corresponding to the SSD 352 found in the step S801 (step S802).

Next, when the MP 303 finds the cache slot 323 of “RAID-5 logical dirty” (step S802: Yes), the MP 303 determines whether a read mode of SSD 352 storing parity data corresponding to the found cache slots 323 is “enable” (step S803).

As a result, when the read mode of the SSD 352 storing the parity is “enable” (step S803: Yes), the MP 303 reads old data and old parity data corresponding to the cache slots 323 found in the step S802 from a plurality of different SSD 352 storing the old data and the old parity data (step S804). After the MP 303 has read the old data and the old parity data, the MP 303 starts the parity calculation circuit 306 to generate new parity data from the old data, the old parity data and new data (dirty data) (step S805). When the MP 303 finishes generating the parity data, the MP 303 sets a slot state of a cache slot 323 corresponding to the relevant data and parity data to “physical dirty”, and finishes the processing (step S806).

When the MP 303 does not find the cache slot 323 of “RAID-5 logical dirty” (step S802: No), or when the read mode of the SSD 352 storing the parity corresponding to the cache slot 323 is not “enable” (step S803: No), the MP 303 finishes the processing.

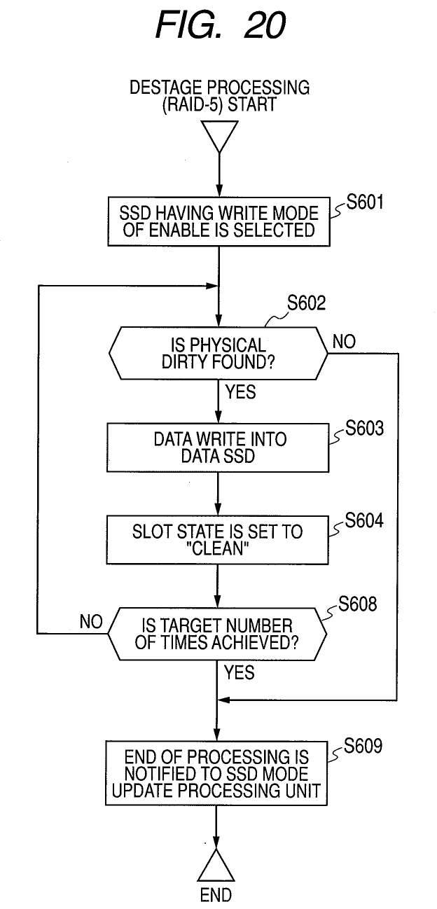

FIG. 20 shows a flowchart of destage processing for a RAID-5 RAID group according to an embodiment of the invention. The same step as in the destage processing for the RAID-10 RAID group shown in FIG. 13 is marked with the same number, and different points are mainly described.

In the destage processing for the RAID-5 RAID group, in the case that the MP 303 cannot find the cache slot 323 corresponding to the SSD 352 (step S602: No), the MP 303 advances the processing to step S609 without performing steps S605 to S607 as shown in FIG. 13.

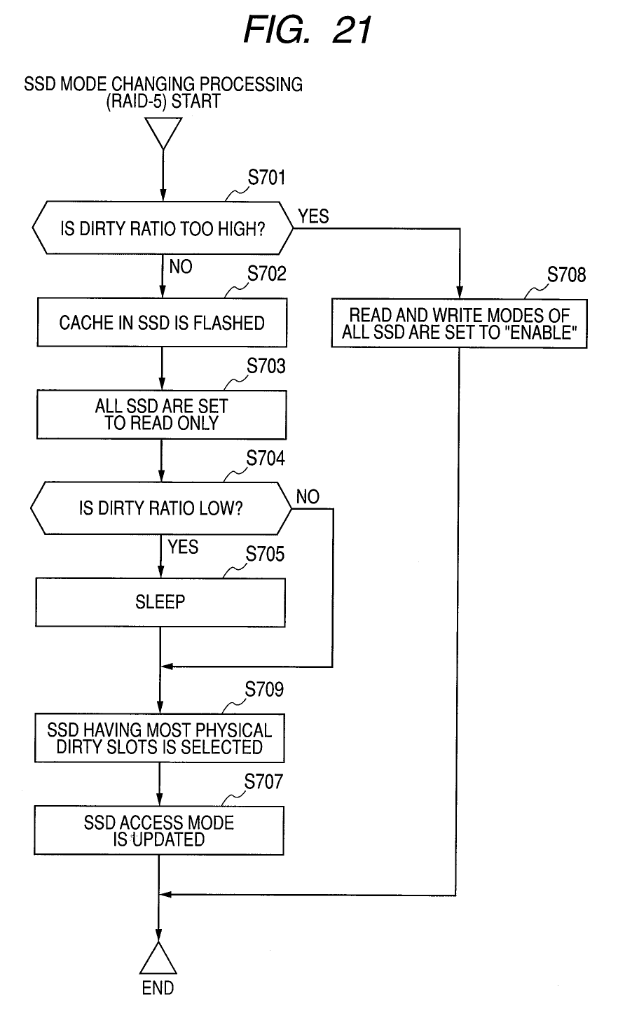

FIG. 21 shows a flowchart of SSD mode changing processing for a RAID-5 RAID group according to an embodiment of the invention. The same step as in the stage processing for the RAID-10 RAID group shown in FIG. 14 is marked with the same number, and different points are mainly described.

In the SSD mode changing processing for the RAID-5 RAID group, in place of the step S706 in FIG. 14, the MP 303 selects SSD 352 based on volume of physical dirty in an object RAID group (step S709). Such selected SSD 352 is set to a destage-enable state. For example, in the case of a 3D+P RAID-5 RAID group configured by four SSD 352, the MP 303 can select one SSD 352 having the largest volume of physical dirty. In the case of a 3D+P RAID-5 RAID group configured by eight SSD 352, the MP 303 can select two SSD 352 belonging to 1D or P including SSD 352 having the largest volume of physical dirty.

Next, a modification of the storage system according to the embodiment is described.

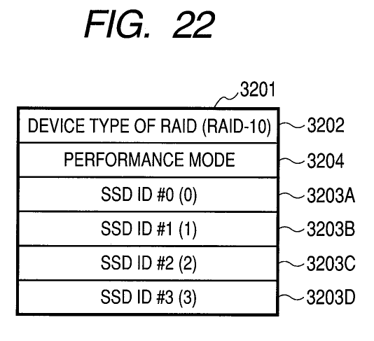

FIG. 22 shows a block diagram of RAID group configuration information according to a modification of the invention. Differences from the RAID group configuration information 3201 shown in FIG. 6 are mainly described.

RAID group configuration information 3205 according to the modification further includes a performance mode 3204 for a RAID group in addition to the RAID group configuration information 3201 shown in FIG. 6.

The performance mode 3204 stores setting (specific information) of “throughput priority” or “response time priority” as setting of an access processing mode for a corresponding RAID group. Such setting may be beforehand set by a user. Alternatively, it is acceptable that the MP 303 monitors access response time or a processing load in processing, and the MP 303 dynamically determines a mode depending on a result of such monitoring. For example, when the processing load is increased, the mode may be set to the throughput priority. When the mode is set to the response time priority, the MP 303 executes processing performed by the SSD mode update processing unit 313 (processing of FIGS. 12 and 13, or processing of FIGS. 18 to 20) for a corresponding RAID group. On the other hand, when the mode is set to the throughput priority, the MP 303 sets read modes and write modes of all SSD 352 in the corresponding RAID group to “enable”.

For example, in the embodiment, when SSD 352 storing stage object data in the RAID-5 RAID group is in a destage-enable state, data are restored by parity calculation. Therefore, the MP 303 needs to perform processing for such restore, and the number of access times to SSD 352 increases. In such a case, overhead of processing performed by the MP 303 or access to the SSD 352 may be a bottle neck depending on a characteristic of a task using a RAID group.

On the other hand, according to the modification, since whether the processing is performed by the SSD mode update processing unit 313 can be determined for each RAID group, the bottle neck due to the overhead of the MP 303 or the SSD 352 can be prevented.

Hereinbefore, the invention has been described according to the embodiment. However, the invention is not limited to the embodiment, and can be applied to various other aspects.

For example, in the destage processing for RAID-10 of the embodiment, when data in a cache slot 323 are not destaged to both of data SSD 352 and mirror SSD 352, the data are first destaged to corresponding mirror SSD 352 (step S606), then destaged to data SSD 352 (step S603 in subsequent processing). However, the invention is not limited to this, and when data in a cache slot 323 are not destaged to both of data SSD 352 and mirror SSD 352, the data may be first destaged to one SSD 352, and then destaged to the other SSD 352.

Moreover, the embodiment is described with the RAID-5 RAID group using parity data as an example. However, the invention is not limited to this, and may be applied to a RAID-6 RAID group. In this case, for example, two SSD 352 are beforehand made in a destage-enable state, and when data in these SSD 352 need to be staged, the data in the SSD 352 can be restored and staged using data and parity data in different SSD 352.

Moreover, in the embodiment, in the destage processing of FIG. 13 or FIG. 20, processing is repeated until predetermined throughput (for example, target number of times) is achieved in step S608. However, the invention is not limited to this, and for example, processing may be repeated until predetermined time is passed. Alternatively, processing may be repeated until target number of times is achieved, or predetermined time is passed.

Moreover, in the embodiment, in the RAID group, SSD at one side of the plurality of SSD is fixed as data SSD, and SSD at the other side is fixed as mirror SSD. However, the invention is not limited to this. It is acceptable that a certain area of SSD at one side is made as a data area, and a certain area of SSD at the other side is made as a corresponding mirror area, or a certain area of SSD at one side is made as a mirror area, and a certain area of SSD at the other side is made as a corresponding data area, so that a mirror area and a data area are mixed in the same (or the same set of) SSD 352.

1. A storage system having a cache memory and a plurality of solid state disks, which writes write object data into the cache memory, and then writes the data into a predetermined solid state disk,
wherein
the plurality of solid state disks include one or more solid state disk for storing data, and one or more, different solid state disk from which the same data as the data stored in the solid state disk can be acquired, and
the storage system has a setting unit that sets the one or more solid state disk to a write-enable state in which write of predetermined data written in the cache memory is enabled, and sets the one or more, different solid state disk, from which the same data as data stored in the one or more solid state disk can be acquired, to a write-disable state in which data write is disabled,
a write control unit that allows predetermined data in the cache memory to be written into the solid state disk being set to the write-enable state,
a receive unit that receives a read request of data stored in the solid state disk from an external device,
an acquisition unit that acquires object data of the read request from the one or more, different solid state disk, from which the same data as data stored in the one or more solid state disk can be acquired, in the case that a storage location of the object data of the read request is the one or more solid state disk being set to the write-enable state; and
a transmit unit that transmits the acquired data to the external device.

2. The storage system according to claim 1,
wherein
the solid state disk performs reclamation processing where data are stored in a recordable manner into a storage area of the solid state disk, and at a predetermined time point, latest data are stored into a new storage area, and a storage area that has become unnecessary is reclaimed into a data-storable area.

3. The storage system according to claim 1,
wherein
the one or more solid state disk and the one or more, different solid state disk are configured to store the same data respectively, and
when the storage location of the object data of the read request is the one or more solid state disk, the acquisition unit reads and acquires the data from the one or more solid state disk.

4. The storage system according to claim 1,
wherein
the storage system has the one or more solid state disk, and a plurality of different solid state disks that store data and parity data from which data in the one or more solid state disk can be restored, and
when the storage location of the object data of the read request is the one or more solid state disk, the acquisition unit reads the data and parity data stored in the plurality of solid state disks, and restores the object data of the read request from the data and parity data.

5. The storage system according to claim 1,
wherein
the setting unit interchanges setting of the solid state disk being set to the write-enable state, and setting of the solid state disk being set to the write-disable state.

6. The storage system according to claim 5,
wherein
when predetermined time has passed, the setting unit interchanges setting of the solid state disk being set to the write-enable state, and setting of the solid state disk being set to the write-disable state.

7. The storage system according to claim 5,
wherein
when predetermined throughput is performed in write processing of data into the solid state disk, the setting unit interchanges setting of the one or more solid state disk being set to the write-enable state, and setting of the one or more solid state disk being set to the write-disable state.

8. The storage system according to claim 6,
wherein
the setting unit determines the solid state disk being set to the write-enable state based on volume of unwritten data left in the cache memory.

9. The storage system according to claim 1,
wherein
the plurality of solid state disks include one or more group configured by one or more solid state disk for storing data, and one or more, different solid state disk from which the same data as the data stored in the one or more solid state disk can be acquired,
the storage system further has a first ratio determination unit that determines whether a ratio of stored data, being not written into the solid state disk of the group, to storage capacity of the cache memory is equal to or lower than a predetermined, first threshold value, and
when the ratio is determined to be equal to or lower than the first threshold value, the setting unit temporarily sets all the solid state disks in the group to the write-disable state.

10. The storage system according to claim 9,
wherein
the storage system further has a load detection unit that detects a load in read and write processing of data in the storage system, and
the setting unit determines time during which the setting unit sets all the solid state disks to the write-disable state depending on the load.

11. The storage system according to claim 1,
wherein
the plurality of solid state disks include one or more group configured by one or more solid state disk for storing data, and one or more, different solid state disk from which the same data as the data stored in the one or more solid state disk can be acquired,
the storage system further has a second ratio determination unit that determines whether a ratio of stored data, being not written into the solid state disk of the group, to storage capacity of the cache memory is more than a predetermined, second threshold value, and
when the ratio is determined to be more than the second threshold value, the setting unit sets all the solid state disks in the group to the write-enable state.

12. The storage system according to claim 1,
wherein
the plurality of solid state disks include one or more group configured by one or more solid state disk for storing data, and one or more, different solid state disk from which the same data as the data stored in the one or more solid state disk can be acquired,
the storage system further has a specific storage unit that stores specific information for specifying whether setting is performed for making all the solid state disks configuring the group into the write-enable state, and
when the specific information for making all the solid state disks into the write-enable state is stored, the setting unit sets all the solid state disks in the group to the write-enable state.

13. The storage system according to claim 1,
wherein
the plurality of solid state disks include one or more group configured by one or more solid state disk for storing data, and one or more, different solid state disk from which the same data as the data stored in the one or more solid state disk can be acquired,
the storage system further has a group load detection unit that detects a load in read and write processing of data from/into the solid state disks configuring the group in the storage system, and
when the load is determined to be more than the third threshold value, the setting unit sets all the solid state disks in the group to the write-enable state.

14. A data response method in a storage system having a cache memory and a plurality of solid state disks, the storage system writing write object data into the cache memory, and then writing the data into a predetermined solid state disk,
wherein
the plurality of solid state disks include one or more solid state disk for storing data, and one or more, different solid state disk from which the same data as the data stored in the one or more solid state disk can be acquired, and
the data response method has a step of setting the one or more solid state disk to a write-enable state in which write of predetermined data written in the cache memory is enabled, and setting the one or more, different solid state disk, from which the same data as data stored in the one or more solid state disk can be acquired, to a write-disable state in which data write is disabled,
a write control step of allowing predetermined data in the cache memory to be written into the solid state disk being set to the write-enable state,
a step of receiving a read request of data stored in the solid state disk from an external device,
a step of acquiring object data of the read request from the one or more, different solid state disk, from which the same data as data stored in the one or more solid state disk can be acquired, in the case that a storage location of the object data of the read request is the one or more solid state disk being set to the write-enable state; and
a step of transmitting the acquired data to the external device.

15. A storage system having a cache memory, a plurality of solid state disks, an interface, and a processor, which writes write object data into the cache memory, and then writes the data into a predetermined solid state disk,
wherein
the solid state disk performs reclamation processing where data are stored in a recordable manner into a storage area of the solid state disk, and at a predetermined time point, latest data are stored into a new storage area, and a storage area that has become unnecessary is reclaimed into a data-storable area,
the plurality of solid state disks include one or more group configured by one or more solid state disk for storing data, and one or more, different solid state disk from which the same data as the data stored in the one or more solid state disk can be acquired, and
the processor
determines whether a ratio of stored data, being not written into the solid state disk, to storage capacity of the cache memory is equal to or lower than a predetermined, first threshold value,
determines whether a ratio of stored data, being not written into the solid state disk, to storage capacity of the cache memory is more than a predetermined, second threshold value,
detects a load in read and write processing of data in the storage system,
stores specific information for specifying whether setting is performed for making all the solid state disks configuring the group into a write-enable state in which data write is enabled,
sets one or more solid state disk to a write-enable state in which write of predetermined data written in the cache memory is enabled, and sets one or more, different solid state disk, from which the same data as data stored in the one or more solid state disk can be acquired, to a write-disable state in which data write is disabled,
sets all the solid state disks to the write-disable state during time depending on the load in the case that the ratio is determined to be equal to or lower than the first threshold value,
sets all the solid state disks to the write-enable state in the case that the ratio is determined to be more than the second threshold value,
sets all the solid state disks in the group to the write-enable state in the case that the specific information for making all the solid state disks into the write-enable state is stored,
allows predetermined data in the cache memory to be written into the solid state disk being set to the write-enable state,
receives a read request of data stored into the solid state disk from an external device via the interface,
acquires object data of the read request from the one or more, different solid state disk, from which the same data as data stored in the one or more solid state disk can be acquired, in the case that a storage location of the object data of the read request is the one or more solid state disk being set to the write-enable state; and
transmits the acquired data to the external device via the interface.
